(19) United States
(12) Patent Application Publication
(10) Pub. No.: US 2026/0048541 A1
(43) Pub. Date: Feb. 19, 2026

(54) Method and Film-Extruding Machine for Producing a Plastics Film

(71) Applicant: Windmöller & Hölscher KG, Lengerich (DE)

(72) Inventors: Markus BUSSMANN, Lengerich (DE); Hans-Udo BECKMANN, Lengerich (DE)

(21) Appl. No.: 19/120,625

(22) PCT Filed: Oct. 17, 2023
(86) PCT No.: PCT/EP2023/078859

§ 371 Date: May 13, 2025

(30) Foreign Application Priority Data
Oct. 17, 2022 (DE) 10 2022 210 951.1

(51) Int. Cl. B29C 48/92; B29C 48/00; B29C 48/08; B29C 48/285; B29K 105/26

(52) U.S. Cl. CPC B29C 48/92; B29C 48/022; B29C 48/08; B29C 48/286; B29C 2948/92019; B29C 2948/92085; B29C 2948/9219; B29C 2948/922; B29C 2948/92209; B29K 2105/26

(57) ABSTRACT

The invention describes a method for producing a plastics film by a film-extruding machine, wherein at least two plastics materials from at least two reservoirs are fed together to one extruder or are each fed to a respective extruder, the plastics materials are melted in the extruder or in the extruders and are conveyed as a melt strand or as melt strands into a die head, the melt Strand or the melt strands are spread out flat in the die head and is/are extruded from a die of the die head as a melt film, and the melt film and/or the film sheet formed by cooling is/are drawn off by at least one take-off roll. It should particularly be noted that measured values are recorded by means of a measuring device for at least one property of at least one plastics material and/or at least one melt strand /d/ or the melt film and/or the film sheet and/or for a machine parameter of the film-extruding machine and that a first plastics material is a plastics material with varying material properties and a second plastics material is a plastics material with substantially constant material properties, wherein the first and the second plastics materials are fed to the extruder or the extruders in relative proportions, the relative proportions being varied according to the measured values for the property.

The invention relates to a method and a film extrusion machine for producing a plastic film according to the preambles of claims 1 and 6.

To produce a plastic film, at least two plastic materials are often provided in at least two storage containers. These plastic materials are usually available in solid but pourable form, for example in granulate form, in some cases also as flakes or as a mixture of both. These at least two plastic materials can be fed together to an extruder. In one alternative, each plastic material is fed to one extruder.

The plastic materials are now melted in the extruder or extruders, usually under the influence of thermal energy and mechanical pressure. If two plastic materials are processed within an extruder, they are mixed and, in particular, homogenized. However, mixing can also take place on the way from the storage containers to the extruder.

After melting, the flowable melt strand is fed from each extruder to a die head. The melt strand is distributed across the width so that a flat melt strand is produced, the width of which is 35 times greater than its thickness, in particular at least 20 times greater.

The melt strand be distributed to form a melt strand in a linear or ring shape. If several melt strands are fed to the die head, they can be combined within the die head to form a multi-layer melt strand. This melt strand is then pressed out of a die of the die head so that a melt film is formed. This now cools down and forms a film web which is, for example, a flat web or, if the melt strand has been distributed in a ring shape, forms a tubular web. The melt film and/or the already formed film web are then drawn off by at least one draw-off roller.

This process and this film extrusion machine can often be used to produce large quantities of film webs. However, the quality of the film web produced over a longer period of time may not be consistent.

The object of the present invention is therefore to propose a process and a film extrusion machine with which the quality of the film webs can be maintained consistently over a longer production period.

According to the invention, this task is solved by all the features of claim 1. Possible embodiments of the invention are given in the dependent claims.

According to the present invention, it is provided that measured values are recorded for at least one property of at least one plastic material and/or at least one melt strand and/or the melt film and/or the film web and/or for a machine parameter of the film extrusion machine by means of a measuring device. This measure makes it possible to carry out quality monitoring not only on the finished film web, but also on preliminary and intermediate products. For example, infrared or radiation measurements can be used to obtain information about the composition of the plastic materials. In this way, changes in the materials that occur over the production period can be observed.

However, changes in a plastic material over time also lead to changes within the extruder during the melting of this material. For example, the temperature of the plastic material within the extruder, in particular within the extruder zones, can change, in particular because the heat capacity of the material can fluctuate. A change in a plastic material can influence the pressure curve in the extruder, whereby the pressure curve results in particular from the back pressure of the material. The duty cycle of the extruder zones can also be monitored. An easy parameter to monitor is the motor torque required to drive a specified speed of an extruder screw inside the extruder.

Measured values for all the aforementioned parameters can be obtained using suitable measuring devices, such as a temperature measuring device, a pressure measuring device or a torque monitoring device.

Furthermore, according to the invention, it is provided that a first plastic material is a plastic material with fluctuating material properties and a second plastic material is a plastic material with essentially constant material properties, wherein the first and the second plastic material are fed to the extruder or extruders in a quantity ratio, wherein the quantity ratio is varied as a function of the measured values for the property.

The first plastic material is one with properties that fluctuate over time during processing in the film extrusion machine, in particular with regard to the intrinsic material composition. Such fluctuating properties are due in particular to the fact that two different volume elements of the first plastic material have different base material compositions. With chemically similar basic structures, different basic materials can have different densities. For example, polyethylenes can be present in a high density (HD-PE), but also in a lower density (LD-PE). The overall density of the plastic material can vary depending on the change in the proportions of these two polyethylenes from volume element to volume element.

Compared to the first plastic material, the second plastic material is a material with essentially constant material properties. Such materials are often produced from high-purity starting materials and in strict compliance with specified manufacturing parameters. Therefore, such second plastic materials are often more expensive than the first plastic materials. The invention can therefore also help to reduce the costs of the film web produced.

In order to be able to compensate for the fluctuating properties of the first plastic material, it is further provided according to the invention that the first and second plastic materials are initially fed to the extruder or extruders in a quantity ratio. In the first case, it is thus provided that both materials are fed in a quantity ratio before entering the extruder. For example, the proportion of the first plastic material can be 70% and the proportion of the second plastic material 30%. It is envisaged that the quantity ratio is varied as a function of the above-mentioned measured values for the above-mentioned property. In the second case, in which the melt strands are combined within the die head to form several layers, the quantity ratio can be determined by the fact that the layer thicknesses assume a certain ratio to one another. For example, with a total layer thickness, the layer thickness of the first plastic material can contribute 70% and the layer thickness of the second plastic material 30% to the total layer thickness.

In both of the aforementioned cases, it may be provided that the second plastic material comprises a quantitative proportion of at least 10% of the total plastic material, but in particular at least 20%. If the second plastic material comprises an additive or if the second plastic material consists only of an additive, it may be provided that the second plastic material comprises a proportion of at least 0.5% of the total plastic material.

An additive can be a secondary component that is added to a main component of the second plastic material. For certain properties of the first plastic material, it may even be sufficient to use only one additive as the second plastic material.

As already mentioned above, measured values for the above-mentioned properties are recorded with at least one measuring device. The measured values are fed in particular to a calculation and control device. The calculation and control device compares the recorded measured values with target values for this property and/or to average values from the previously obtained measured values. If the difference between the values and the target or average values exceeds a limit value, the quantity ratio of the first plastic material and the second plastic material is varied, i.e. in particular adjusted. This means in particular that the supply of the first plastic material is changed or reduced and/or the supply of the second plastic material is also changed, in particular increased, until the measured values are again below the limit value. It is preferable to change the supply of both plastic materials in order to keep the total quantity constant.

In an advantageous embodiment of the invention, the first plastic material is a recycled plastic material. A recycled plastic material is characterized by the fact that it contains a plastic material that has already been used by a user. Since materials from different initial applications of the plastic often enter a recycling plant one after the other, the properties within the material can vary greatly. This applies with regard to the material composition, but also with regard to possible contamination by foreign substances, which are undesirable but usually unavoidable. Overall, the invention thus offers the possibility of processing recycled material in a film extrusion machine, whereby the quality of the film web produced is improved compared to conventional methods.

It is advantageous if at least one of the following properties is among the properties for which measured values are recorded with a measuring device: Bubble stability, bubble shape, frost line height or frost zone height, film temperature, film thickness, draw-off speed, film width.

Bubble stability describes whether the melt film moves along an intended transport path or whether the actual transport path deviates from this. In practice, this is often referred to as “fluttering” of the film, i.e. periodic deviations from the intended transport path. An optical camera can be provided here as a measuring device. The images recorded by this camera form the measured values and can be evaluated with regard to the aforementioned deviations.

The bubble shape describes whether the geometry of the melt film describes an intended geometry. In practice, it happens that the shape of the melt film changes due to external influences, such as cooling of the environment of the film extrusion machine. In the context of the present invention, however, it is possible that such changes are due to the properties of the first material. An optical camera is again suitable as a measuring device for assessing the bubble shape. The images from the camera are again to be understood as measured values, whereby the actual shape of the melt film in the area of the film bubble can be compared with a target shape for evaluation.

The frost zone is the transition area in which the melt film solidifies into the film web. The film web therefore no longer forms a melt, but a solid film web, which in particular cannot be formed or at least can no longer be formed significantly. The frost zone is often referred to as a frost line. The frost zone height refers to the distance of the frost zone from the die along the transport path. Even if the term “height” is derived from blown film extrusion, the distance described can also be determined in a flat film extrusion machine.

The frost zone height can vary, particularly during extrusion operation, because the heat capacity of the first plastic material in particular varies over time. Knowledge of the frost zone height is important for the adjustment or positioning of machine components, for example for the position of the calibration cage. The frost zone can be determined by measuring the temperature of the film bubble, for example using an infrared camera. If an increased or decreased temperature is detected compared to a target temperature or an average temperature, this means that the frost zone has shifted in or against the transport direction.

In film extrusion machines, a separate control circuit is often also provided for the height of the calibration cage and/or for the height of the frost zone, so that the measured variable of this control circuit can be provided as a measured value for the property of the first plastic material.

In general, the film temperature can also be determined at other locations using a temperature measuring device. As already described in connection with the frost zone, the film temperature can depend in particular on the heat capacity of the first plastic material and thus on its properties, such as its chemical composition.

The film thickness is also a property of the resulting film web, which can depend on the properties of the plastic materials used. Thus, the varying properties of the first plastic material can lead to a varying film thickness. Thus, the film thickness can preferably be determined using a measuring device that works on the basis of ultrasonic or radiometric waves or one that works on the basis of a tactile measurement. There are particular advantages if such a measurement is carried out in combination with a measurement of the electrical capacitance. The capacitance measurement with electrodes provides results that depend on the density of the materials of the film web for a given thickness of the film.

If the thickness of the film web changes in addition to the density, both must be determined independently of each other. Consequently, both the thickness and the density can be determined individually using two measuring devices on different physical measuring principles. The density of the film web in turn allows conclusions to be drawn about the density of the first plastic material, so that corrections must be made to the quantity composition of the first and second plastic materials in the event of deviations from a target density.

The width of the film can also be determined using a width measuring device and also provides an indication of the properties of the first plastic material. The film width depends in particular on the stretchability of the film and therefore directly on the properties of the first plastic material.

The haul-off speed of the film web, i.e. the circumferential speed of the haul-off roller at a given torque, also depends on the properties of the first plastic material, in particular its density. The circumferential speed can be measured using an angle sensor with a known outer circumference of the draw-off roller.

The properties of the first plastic material can be determined with these aforementioned measuring devices, but also with the measuring devices mentioned below, the lists of which are not exhaustive, whereby the measured values of the measuring devices can be taken into account individually or jointly. The measured values are preferably compared with target values and/or with the average values in a calculation and control device. In the event of deviations above a threshold value, the quantity ratios of the first and the at least one second plastic material are changed in accordance with the invention. It may be provided, if several measured values are taken into account by the calculation and control device, these are weighted in order, for example, to be able to take their influence into account. It may also be provided that these weightings are repeatedly checked and adjusted with regard to their influence.

These weightings can be stored or saved in a memory device of the film extrusion machine and/or the calculation and control device. In this way, data from previous film productions 5 can be accessed during a current film production, so that when a new film production starts, good production is achieved more quickly. Of course, such data is stored in conjunction with a recipe, whereby a recipe includes not only the type of plastic materials and their quantity supply for the production of the intended film, but also the machine parameters, such as the positioning of the calibration cage, and the method parameters, such as the rotational speed of an extruder screw. In particular, it is advantageous if the calculation and control device varies the quantity ratio, especially over a previously defined variation range, and records the influence on the measured values. From this, mixing rules can be generated and stored, which can be recipe-specific and in particular specific for different first plastic materials. Such a variation can also be achieved by providing a test extruder outside the film extrusion machine, to which the first plastic material and the at least one second plastic material are fed in different proportions and the measured values are determined.

Not only the properties of the melt film and/or the film web, but also the properties of the melt strand can be measured using measuring equipment. These properties include:
pressure curve in the extruder,
temperature of the extruder zones,
density,
viscosity number,
back pressure,
feed rate.

This list is not exhaustive either.

The pressure curve in the extruder depends directly on the properties, in particular the densities, of the plastic materials used and can be measured using pressure measuring equipment. In particular, the pressure drop across a sieve device can also be determined. These measured values are in turn fed to the calculation and control device.

The temperature of the melt flow in individual zones of the extruder (extruder zones) can also be determined with known temperature sensors and provide an indication of the properties of the first plastic material.

Density can be determined at different locations within the film extrusion machine and with density measuring devices. However, the density can also be measured directly on the plastic material that has not yet melted. Not only the density within a granulate grain or a flake of the first plastic material can play a role here, but also the bulk density of the material, particularly within a storage container.

The viscosity number of the melt strand, which can also be referred to as MFI (abbreviation for “melt flow index”), can be measured inside the extruder or extruders with at least one viscosity number measuring device and/or, for example, inside pipelines between the extruder and die head and/or inside the die head.

A back pressure generated by the melt strand can also be determined and provides an indication of the properties of the first plastic material.

The conveying rate, i.e. the conveyed volume or the conveyed weight per unit of time, can be determined using a measuring device set up for this purpose.

It is also advantageous if at least one of the following parameters is included in the properties of at least one machine parameter:
duty cycle of the extruder zones,
motor torque of the extruder drive,
supply and/or removal of the external and/or internal cooling air.

The duty cycle means that it takes a certain amount of time from the start of the extruder(s) until the extruder or its individual zones have reached the operating temperature or the operating pressures are reached. This can also include the time it takes for an extruder screw to reach a nominal number of revolutions. The operating temperature or the operating pressures can be determined using temperature or pressure measuring sensors.

The motor torque can be determined in a simple way, for example by determining the current consumption at a specified speed. The motor torque can be an indication of the density of the first and/or second plastic material. The motor torque in particular can react very sensitively to changes in the material fed to the extruder.

The supply of internal cooling air via an internal cooling device serves on the one hand to bring the film bubble into the intended shape and on the other hand to extract heat from the melt film so that it solidifies to form a film web. In order to remove the extracted heat, the internal cooling air must be dissipated again. Blowers are usually available for supplying and removing the cooling air. Control loops are often provided for the bubble shape and/or for the temperature of the film bubble, so that the measured variables for this control loop and/or the control variables can be used as measured values for determining the properties of the first plastic material. The same applies to the supply of external cooling air by means of an external cooling device, which also serves to absorb heat from the melt film. The only difference to the internal cooling device is that the external cooling air does not have to be discharged, as it escapes into the environment. In contrast, the external cooling air is often temperature-controlled, so that a control loop is also provided for this. Here too, the control variable can be used to determine the properties of the first plastic material.

The task mentioned at the beginning is also solved by a film extrusion machine for producing a plastic film according to a method according to the invention, with
at least two storage containers for providing one plastic material each
at least one extruder, to which the plastic materials can be fed from both storage containers, or at least two extruders, to each of which a plastic material can be fed, the plastic materials being meltable in the extruder or in the extruders and transformable into one melt strand or two melt strands
a die head to which the melt strand or strands can be fed and in which the melt strand or strands can be distributed over a large area by means of a distributor
a die arranged on or in the die head, from which the melt strands formed into a melt film can be pressed out
a haul-off roller with which the melt film and/or the film web formed by cooling can be drawn off the die.

This film extrusion machine is characterized in that a measuring device is provided, with which measured values can be recorded for at least one property of at least one plastic material and/or at least one melt strand and/or the melt film and/or the film web and/or for a machine parameter of the film extrusion machine, in that a first plastic material is a plastic material with fluctuating material properties and a second plastic material is a plastic material with essentially constant material properties, and in that a calculation and control device is provided and is set up so that the first and the second plastic material can be fed to the extruder or extruders in a quantity ratio, it being possible to vary the quantity ratio as a function of the measured values for the property in order to maintain production parameters of the film extrusion machine at essentially constant values.

This achieves the same advantages as those already described in connection with the method according to the invention.

Further advantages, features and details of the invention are shown in the following description, in which various embodiments are explained in detail with reference to the figures. The features mentioned in the claims and in the description can each be essential to the invention individually or in any combination of mentioned features. In the context of the entire disclosure, features and details which are described in connection with the method according to the invention naturally also apply in connection with the film extrusion machine according to the invention and vice versa, so that reference is or can always be made reciprocally to the individual aspects of the invention with respect to the disclosure. The individual figures show:

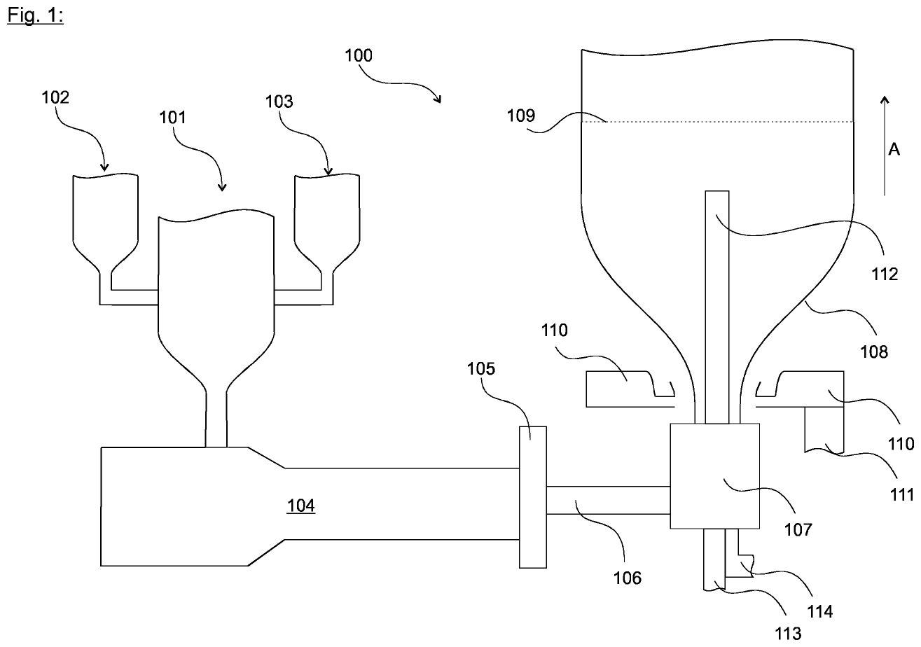

FIG. 1 Schematic sketch of a first film extrusion machine

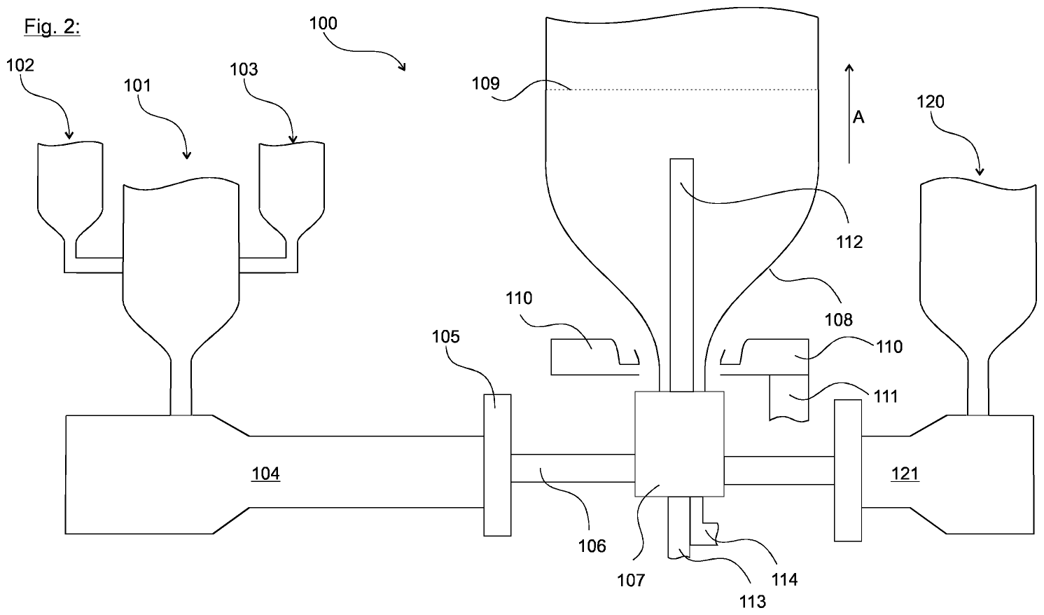

FIG. 2 Schematic sketch of a second film extrusion machine

FIG. 1 shows a schematic diagram of a first film extrusion machine, which is designed as a blown film extrusion machine 100. This machine initially comprises a dosing hopper 101, in which a first plastic material is fed. This first plastic material is in particular a recycled plastic material with varying properties, which is present in granulated form. This material can therefore also be referred to as “ReGran”. This material has first material properties, in particular a first density and a first melt flow index.

Within the dosing hopper 101, at least a second plastic material can be mixed with the first plastic material, which can be fed by means of the dosing hopper 102 and/or the dosing hopper 103. The second plastic material has certain properties, in particular a second density and a second melt flow index. The mixture of the first and the at least one second plastic material has a mixture density which is set, for example, using the method according to the invention. The respective melt flow of the plastic materials can be influenced, so that the mixture has a variable proportion of the plastic materials depending on the desired properties.

The first and the at least second plastic material can be fed to an extruder 104, which comprises a rotating extruder screw. The drive is provided by an electric motor, not shown in detail, whose torque can be measured, in particular by measuring the motor current.

The mixture is melted and homogenized in the extruder 105. This then forms a melt strand. The energy required for melting and/or for setting certain temperatures of the mixture can, in addition to the temperature itself, represent a measured variable for the method according to the invention.

The melt strand then passes through a sieve 105, resulting in a pressure difference between the melt strand upstream and downstream of the sieve 105. The inlet pressure and the outlet pressure depend on the material and are therefore suitable measured variables.

The melt strand passes through a further pipe 106 into a blow head 107. The melt flow index of the melt strand can be measured inside the pipe 106. Over the length of the pipeline, a further pressure change can occur within the melt strand, whereby an inlet pressure can prevail at the blow head, which can be measured.

The melt strand is distributed in a ring shape in the blow head 107 and pressed out through a die. The resulting film tube 108 is drawn off in the transport direction A by means of haul-off rollers not shown. During this transport, the film tube 108 solidifies to such an extent that its dimensions, in particular its diameter and the thickness of the film, no longer change, whereby this transition area is represented by the frost line 109. The diameter of the film tube 108 in the region of the frost line 109 and also the distance of the frost line from the die of the blowing head as seen in the transport direction are characteristic of the material mixture used and can therefore also represent measured variables within the meaning of the invention. In general, the film contour and/or the film temperature as a function of the distance from the die (viewed in the transport direction) can represent measured variables.

In order to be able to influence the shape and/or the temperature of the film tube 108 and/or the thickness of the film and thus also the height of the frost line, at least one cooling ring 110 is provided, which can be supplied with a cooling fluid via the at least one nozzle 111. The volume flow and/or the temperature of the cooling fluid can be influenced, preferably locally differently.

The shape and/or the temperature of the film tube 108 can alternatively or additionally be influenced by means of an internal cooling device 112. A cooling fluid for internal cooling can be supplied to this internal cooling device via a nozzle 113. Since the supplied cooling fluid for the internal cooling cannot escape into the environment, it is necessary to discharge the cooling fluid for the internal cooling. This takes place via a nozzle 114.

In connection with the blown film line 100 described, some of the parameters mentioned are variables that can be adjusted (controlled variables). These controlled variables include, among others, the mass flow, the density and the melt flow index of the at least one second plastic material, the speed of the drive motor for the extruder screw and/or the volume flows and/or temperatures of the cooling fluids. These control variables can be used to influence the properties of the film.

In particular, the density of the mixture, the temperature of the mixture, the inlet pressure at the blow head, the melt flow index of the melt strand, the diameter of the film tube at the position of the frost line and/or the frost line height are influenced by these control variables. In particular, these variables are measurable and can be compared with target values in order to establish at least one control loop.

FIG. 2 shows a further embodiment, which differs from the embodiment according to FIG. 1 in that the at least one second plastic material can be fed via the dosing hopper 120 and melted in the extruder 121. This second melt strand is also fed to the die head and distributed in a ring shape. This melt strand then comes into contact with the melt strand originating from the first extruder 104 and distributed in a ring shape, so that a 20 multilayer film is formed, whereby the properties of the individual layers can be varied.

It should be noted that an embodiment according to FIG. 1 can also be extended in such a way that multilayer films can be produced. As is known, an extruder is provided for each layer. The melt strands from the individual extruders are then distributed in a ring shape and brought together. At least one melt strand can comprise a mixture of a first plastic material with varying properties and at least one second plastic material with essentially constant properties, as described in connection with FIG. 1. Further features of the description of FIG. 1 can of course be transferred to an extrusion system for producing a multilayer film.

Furthermore, the essential features of the invention, which have been presented in connection with the descriptions of the figures for blown film lines, can also be transferred to so-called flat film lines. The differences essentially concern the components located downstream from the die head. A slot die is comparable to a ring die in the blown film line, a chill roll takes over both the cooling of the melt and the removal of the resulting film. These functions are provided in a blown film line by a haul-off device and the cooling ring or internal cooling.

1. Method for the production of a plastic film with a film extrusion machine, whereby
at least two plastic materials from at least two storage containers are fed to an extruder together or to one extruder at a time,
the plastic materials are melted in the extruder or extruders and conveyed into a die head as a melt strand or melt strands,
the melt strand or the melt strands are distributed over a large area in the die head and are pressed out of a die of the die head as a melt film
the melt film and/or the film web formed by cooling is or are drawn off with at least one haul-off roller,
characterized
in that measured values are recorded for at least one property of at least one plastic material and/or at least one melt strand and/or the melt film and/or the film web and/or a machine parameter of the film extrusion machine by means of a measuring device, and
in that a first plastic material is a plastic material with fluctuating material properties and a second plastic material is a plastic material with essentially constant material properties, the first and second plastic materials being fed to the extruder or extruders in a quantity ratio, the quantity ratio being varied as a function of the measured values for the property.

2. Method according to claim 1,
characterized in that
the first plastic material is a recycled plastic material.

3. Method according to claim 1,
characterized in that
the properties of the melt film and/or the film web include at least one of the following properties:
Bubble stability,
Bubble shape,
Frost zone height,
Film temperature,
Film thickness
Haul-off speed,
Film width.

4. Method according to claim 1,
characterized in that
the properties of at least one melt strand include at least one of the following properties:
Pressure curve in the extruder,
Temperature of the extruder zones,
Density,
Viscosity number,
Counter pressure,
Conveyance rate.

5. Method according to claim 1,
characterized in that
the properties of at least machine parameters include at least one of the following parameters:
Duty cycle of the extruder zones,
Motor torque of the extruder drive,
Supply and/or removal of outside and/or inside cooling air.

6. Film extrusion machine for producing a plastic film by the method according to claim 1, comprising
at least two storage containers for providing one plastic material each
at least one extruder, to which the plastic materials can be fed from both storage containers, or at least two extruders, to each of which a plastic material can be fed, the plastic materials being meltable in the extruder or in the extruders and formable into one melt strand or two melt strands
a die head to which the melt strand or strands can be fed and in which the melt strand or strands can be distributed over a large area by means of a distributor a die arranged on or in the die head, from which the melt strands formed into a melt film can be pressed out
a haul-off roller with which the melt film and/or the film web formed by cooling can be drawn off the die,
characterized
in that a measuring device is provided with which measured values can be recorded for at least one property of at least one plastic material and/or at least one melt strand and/or the melt film and/or the film web and/or for a machine parameter of the film extrusion machine, and
in that a first plastic material is a plastic material with fluctuating material properties and a second plastic material is a plastic material with essentially constant material properties, and
in that a calculation and control device is provided and is set up so that the first and the second plastic material can be fed to the extruder or extruders in a quantity ratio, the quantity ratio being variable as a function of the measured values for the property in order to maintain production parameters of the film extrusion machine at essentially constant values.
